(19) United States
(12) Patent Application Publication
(10) Pub. No.: US 2026/0056167 A1
(43) Pub. Date: Feb. 26, 2026

(54) CHAIN SENSOR DEVICE AND METHOD FOR DETERMINING WEAR

(71) Applicant: iwis antriebssysteme GmbH & Co. KG, München (DE)

(72) Inventors: Thomas Wolf, Erdweg (DE); Florian Wimmer, München (DE)

(73) Assignee: iwis antriebssysteme GmbH & Co. KG, München (DE)

(21) Appl. No.: 19/376,960

(22) Filed: Nov. 2, 2025

Related U.S. Application Data
(63) Continuation-in-part of application No. 17/705,669, filed on Mar. 28, 2022, now Pat. No. 12,460,918.

(30) Foreign Application Priority Data
Mar. 29, 2021 (DE) 10 2021 107 899.7

(51) Int. Cl. G01N 27/72

(52) U.S. Cl. CPC G01N 27/72

(57) ABSTRACT

The invention relates to a method for setting up a sensor device for monitoring the state of wear of a chain, which method comprises the steps: first positioning of the first sensor system relative to a calibration object, first positioning of the second sensor system relative to the calibration object, carrying out a first signal detection using the first sensor system, carrying out a second signal detection using the second sensor system, wherein the first signal detection using the first sensor system takes place at the same time as the first signal detection of the second sensor system.

### CROSS-REFERENCE TO RELATED APPLICATIONS

The present application is a Continuation-In-Part (“CIP”) application of U.S. application Ser. No. 17/705,609 filed on Mar. 28, 2022, which claims priority from German patent application No. 10 2021 107 899.7, filed on Mar. 29, 2021, the contents of which are incorporated by reference herein in their entirety.

### FIELD

The present disclosure generally relates to a method for setting up a sensor device for monitoring the state of wear of a chain, which comprises the steps: first positioning of the first sensor system relative to a calibration object, first positioning of the second sensor system relative to the calibration object, carrying out a first signal detection using the first sensor system, carrying out a second signal detection using the second sensor system, wherein the first signal detection using the first sensor system takes place at the same time as the second signal detection of the second sensor system.

### BACKGROUND

Chain drives are used in a variety of industrial applications for drive or transport purposes. Multiple strands of chain are often used. In addition to a mostly endlessly circulating chain, a complete chain drive includes several sprockets that are used to deflect the chain, as well as drive or transport elements that are connected to the chain and are actuated by the chain. A chain is subject to wear during operation as a result of the abrasion of parts in the chain joint that move relative to one another. Other factors, such as elongation at chain run-in, stretching, bearing play and bearing wear, can also lead to elongation of the chain and ultimately to failure of the drive unit. Other factors influencing the wear of a chain are the forces that act on the chain and loads, or external influences determined by the environment. Due to the complexity of these relationships, it is not possible to predict the wear of the chain and thus a possible disruption in the operational process or even the failure of the drive unit. Since the wear of a drive chain or its elongation cannot be avoided and cannot be reliably predetermined, a chain drive must be continuously monitored using a measuring system in order to be able to carry out timely inspections to adjust the synchronized processes and replace defective chains.

Conventional measuring systems require for an accurate measurement of the chain elongation a drive with a constant speed and react with measurement errors to irregularities in the drive system, for example a relative slippage between the drive wheel and the drive chain or the wear of the sprockets.

Furthermore, it is known from the prior art to determine the wear of a drive chain by measuring the force, the path or the angle of rotation of chain tensioners or by means of two angle of rotation sensors on the drive wheel and on the load wheel. However, a chain tensioner is not needed everywhere, and rotation angle sensors cannot be used everywhere either. In addition, these are then influenced by wear or chain elongation. However, such methods must be precisely matched to the specific method, since the measurement in these cases depends on the total chain length and also on the wear of the sprockets. The adjustment is very complex and error-prone. Therefore, these methods are not generically applicable. Other known measuring systems have at least two optical or inductive sensors which are at a defined distance from one another and continuously measure the length of the chain during operation.

Such a measuring system is presented, for example, in U.S. Pat. No. 5,291,131. In this method, two markings spaced apart in the longitudinal direction of the chain are provided on the drive chain, the position of the markings being detected during operation by two inductive or optical sensors, which are also arranged at a distance from one another. The rotational speed of the chain and the chain elongation in the chain segment between the spaced markings can be determined from the measured values of the two sensors via a connected data acquisition system.

### SUMMARY

Setting the defined distance between the two sensors is usually a lengthy process that takes place in several passes. For optimizing the manufacturing process, a reproducible method is required to precisely determine the optimal distances between the sensors. The positions of the sensors are subject to fluctuations due to the sensor geometry, the influence of different chain geometries and the mechanical and metrological tolerances.

The object of the invention is therefore to provide a method for setting up a sensor device for monitoring the state of wear of a chain, with which the positions and distances between the sensor systems can be set and determined reliably, precisely and quickly. It is also an object of the invention to provide a sensor device with which error states of the monitored chain can be detected reliably and quickly, the elongation of each individual chain segment is determined, the monitored chain does not have to have a minimum speed, and the elongation of the chain can also be statistically detected over a longer period of time.

The object is achieved by means of the method according to the invention for setting up a sensor device for monitoring the state of wear of a chain. Advantageous embodiments of the invention are set out in the dependent claims.

The method according to the invention for setting up a sensor device for monitoring the state of wear of a chain comprises four steps. In the first step, the first sensor system is first positioned relative to a calibration object. In the second step, the second sensor system is first positioned relative to a calibration object. Both sensor systems are thus aligned and positioned using a calibration object in such a way that they are at a defined distance from one another. The distance between the two sensor systems depends on the pitch of the chain that is to be monitored using the sensor systems. Different distances between the sensor systems are therefore necessary for different pitches of different chains to be monitored. In the third step, a first signal is detected by the first sensor system, wherein the first signal detected by the first sensor system indicates the position of a first element of the calibration object and a second signal is detected by the second sensor system, wherein the second signal detected by the second sensor system indicates the position of a second element of the calibration object. According to the invention, the signals indicating the positions of the first and the second element of the calibration object of both sensor systems are detected simultaneously. In case a chain is part of the calibration object the two sensor systems each detect signals from a chain component at the same time wherein the signals detected from these chain components are used to analyze the distance between these two chain components. By using a calibration object, the method according to the invention provides a reproducible distance between the two sensor systems. The sensor device is suitable to monitor the state of wear of a chain different from the calibration object In a development of the invention, the two sensor systems form a sensor device.

In an embodiment of the invention the signals detected by the first and the second sensor systems indicating the positions of the first and the second elements of the calibration object are then used to adjust the first and/or the second sensor system to a defined distance and/or to calculate the distance between the first and the second sensor system.

In a further embodiment of the invention the first and the second sensor with defined distance between each other are used for monitoring the state of wear of an unknown chain different from the calibration object. By using a calibration object, the method according to the invention provides a reproducible distance between the two sensor systems. In a development of the invention, the two sensor systems form a sensor device. The calibrated sensor device can be mounted nearby a chain to be monitored without changing the configuration of the sensor device or changing the distance between the first and the second sensor system.

In a further embodiment of the invention the method of monitoring the state of wear comprise simultaneously detecting a first signal from a first chain component by the first sensor system indicating the position of the first chain component and detecting a second signal from a second chain component by the second sensor system indicating the position of the second chain component, wherein the first and the second signal are used for analyzing the state of wear of the chain to be monitored. In a further embodiment the first and the second signal are used for analyzing the elongation of the chain to be monitored. In a further embodiment the first and the second signal are used for determining the distance between the first and the second chain component of the chain to be monitored.

In an embodiment of the invention the distance of the first and the second sensor is determined by positioning the first and the second sensor system in a defined manner relative to the calibration object. The first and the second sensor system are positioned using the physical and/or geometrical dimensions of the calibration object. In one example the first and the second sensor a brought into direct contact with the calibration object. The distance of the first and the second sensor system is then directly determined from the known length of the calibration object. In an other example the calibration object is able to measure and/or determine the position of the first and second sensor system relative to the distance between the two sensors to be setup. The first and the second sensor systems can then be adjusted according to the positions measured and/or determined by the calibration object.

In a development of the invention the positions of the first and the second sensor systems are fixed after the calibration. Its important to keep the two sensor systems and therefore their distance fixed in order to achieve correct results while monitoring the wear of a chain.

In a further embodiment of the invention the monitoring the state of wear of a chain with a unknown state of wear is done with the fixed first and second sensor system.

In a further embodiment of the invention the distance between the two sensors is used for monitoring the state of wear of a chain. In a further development of the invention the length and/or elongation of the unknown chain is determined with the fixed first and second sensor system. In a further development of the invention the distance between the first and the second sensor system is used to determine length and or elongation of a chain. The elongation is a direct measure for the wear of a chain. Using the defined and known distance of the first and the second sensor system the elongation of the chain can be determined.

In a development of the invention, the first positioning of the first sensor system and the first positioning of the second sensor system take place at the same time. The first and second sensor systems are usually arranged in one component, for example a housing. The component is positioned with the sensor systems installed in it.

In a further embodiment of the invention, the first and/or the second sensor system is positioned a second time relative to the calibration object, the second positioning being different from the first positioning, and/or a second signal detection takes place with the first and/or second sensor system. The method according to the invention is advantageously carried out several times in succession at different positions on the calibration object in order to detect and compensate for any fault states due to different chain geometries over the chain length and due to mechanical and metrological tolerances.

In a further embodiment of the invention, the second positioning of the first and the second sensor system and/or the second signal detection by the first and the second sensor system takes place at the same time during the calibration process and/or the monitoring of the wear state of a chain. The first and second sensor systems are usually arranged in one component, for example a housing with a fixed distance between each other. The component is positioned with the sensor systems installed in it. According to the invention, the first signal detection of the first sensor system and the second signal detection of the second sensor system take place simultaneously with regard to whether the two sensor systems detect a chain component at the same time independently from the state of wear of the chain to be monitored. Most systems using laser barriers for triggering a marker or chain element passing the first and/or second sensor system. Those sensor elements are not suitable for detecting a signal by the first and the second sensor system at the same time independently of the wear state of the chain, because by the elongation caused by the wear time of the signal detected by the first sensor system is shifted relative to the signal detected by the second sensor system. Therefore a sensor system has to be used, which is suitable to detect the position of a marker of the chain and/or a chain component independently from its specific position at least over small detection area.

In a further embodiment of the invention, the calibration object is designed in two parts. In a development of the invention, the first part of the calibration object is a chain. In particular, the chain is of the type of chain to be monitored by the sensor system.

In a further embodiment of the invention, the second part of the calibration object is an element with the aid of which chain components can be positioned in relation to one another. Depending on the chain components to be positioned, the second part of the calibration object has elements with which the chain components can be connected or the position of which can be clearly identified. These elements can act, for example, mechanically (e.g. grooves) or optically (e.g. by means of image recognition).

In a further embodiment of the invention, the method for setting up a sensor device for monitoring the state of wear of a chain takes place based on the chain type for which the sensor is to be used. The individual chain types differ in various dimensions, e.g. the pitch. The method according to the invention must therefore be matched to each type of chain to be monitored.

In a further embodiment of the invention, the chain type is a standard chain. A standard chain has standard components with standard dimensions according to DIN 8187 or DIN 8188.

In a development of the invention, the chain type is a standard chain according to British Standard (DIN 8188) or ANSI Standard (DIN 8187). The individual dimensions of the chain components are partly different in the British Standard chain and in the ANSI Standard. The roller diameters, for example, often differ.

In a further embodiment of the invention, the method for setting up a sensor device for monitoring the state of wear of a chain takes place based on the pitch of the chain for which the sensor is intended. The distance between the two sensor systems is usually an integer multiple of the pitch of the chain to be monitored in order to simultaneously detect the position of a first chain component using the first sensor system and the position of a second chain component using the second sensor system. In case a sensor system is used which is suitable to detect the position of a marker of the chain and/or a chain component independently from its specific position at least over small detection area, the detection areas of the first and the second sensor systems the distance between the two sensor systems don't have to be exactly an integer multiple of the pitch of the chain to be monitored in order to simultaneously detect the position of a first chain component using the first sensor system and the position of a second chain component using the second sensor system. But the difference of the distance of the two sensors to an integer of the pitch of the chain has to be smaller than the detection areas of the first and/or the second sensor systems.

In a development of the invention, the pitch of the chain corresponds to 12.700 mm, 15.875 mm, 19.050 mm, 25.400 mm, 31.750 mm, 38.100 mm, 44.450 mm or 50.800 mm. The pitches of the standard chains according to British Standard (DIN 8188) or ANSI Standard (DIN 8187) are the same.

In a further embodiment of the invention, the first sensor system and/or the second sensor system are suitable for detecting the position of a chain component. The sensor systems are at a defined distance from one another, which corresponds to the pitch or an integer multiple of the pitch of the chain. The distance between the two sensors is a parameter for calculating the length value of the chain. The signals to the first and second sensor systems are detected continuously and simultaneously during monitoring the wear state of the chain. In a further embodiment of the invention the wear state of the chain, the elongation and/or the length value, like the distance between the chain components, is continuously and simultaneously determined.

In a further embodiment of the invention, the first and/or the second sensor system are suitable for detecting the signals of a chain component, in order to determine the position of the chain component simultaneously over a path length range of the chain for which the sensor (the sensor system) is provided. The sensor systems are position sensitive sensors and constructed in such a way that the position of the chain component is determined over a length range. The signals detected by the sensor system during the calibration process and/or during the monitoring process are coming simultaneously from different positions and/or elements of the calibration object or the chain to be monitored. By this way a marker or specific chain component can be simultaneously detected over a pathlength of the chain without changing the configuration of the sensor device or the position of one of the sensor systems. The chain components therefore cover a distance in the detection range of the sensors, within which the position of the chain components is determined.

In a further embodiment of the invention, the path length range is greater than or equal to ½ the pitch of the chain, preferably greater than or equal to ¾ the pitch of the chain and particularly preferably greater than or equal to the pitch of the chain for which the sensor (the sensor system) is provided. The segments provide a complete coverage of at least those parts of the chain that are accessible to the chain sensor device for detecting the position. The length or number of segments depends on the length of the chain to be monitored.

In an optional embodiment of the invention, the first and/or the second sensor of the sensor device detect the measured values for determining the position of the chain components independently of the speed and/or the position of the chain to be monitored. In a further optional embodiment, the first and/or the second sensor detect the measured values for determining the position of the chain components when the chain speed is 0.

In a further embodiment of the invention, the measured values for determining the position of a chain component are continuously detected and the position of the chain component is continuously determined from these measured values.

In an optional development of the invention, the first and/or the second sensor simultaneously detect the measured values for determining the position of a chain component over the path length range of the chain.

In a development of the invention, the sensor device simultaneously detects the measured values from the first and/or the second sensor over a length range of the chain. The length range of the chain extends in the direction of movement of the chain. When using sensor systems detecting during the calibration process and/or during the monitoring process are coming simultaneously from different positions of the calibration object or the chain to be monitored the marker or the chain component can be watched while moving.

In a further embodiment of the invention, the length range is greater than or equal to half the length of a chain link, preferably greater than or equal to ¾ the length of a chain link and particularly preferably greater than the length of a chain link. The length of a chain link results from the defined standard according to a standard chain according to British Standard (DIN 8188) or ANSI Standard (DIN 8187).

In a further embodiment according to the invention, the first and/or the second sensor have at least two sensor elements forming the first and/or the second sensor. These are the primary coil and the secondary coils of the differential transformer or, for example, two or more photodiodes of a CCD chip, which are arranged along the direction of chain movement. The distance between the at least two sensor elements is limited to a length of less than twice a chain link of the chain to be monitored. The length of a chain link results from the defined standard according to a standard chain according to British Standard (DIN 8188) or ANSI Standard (DIN 8187).

The object is also achieved by means of the sensor device for determining state of wears of a chain. Additional advantageous embodiments of the invention are set out in the dependent claims.

The sensor device according to the invention for determining state of wears of a chain has a first sensor system and a second sensor system. According to the invention, the sensor device is set up with a calibration object for a standard chain and/or a standard pitch. A standard chain has standard components with standard dimensions according to DIN 8187 or DIN 8188, wherein the sensor device is suitable to monitor the state of wear of a chain different from the calibration object.

In an embodiment of the invention the sensor device has been calibrated by the method described above.

In a further embodiment of the invention the sensor device is suitable to detect a first signal by the first sensor system, wherein the first signal detected by the first sensor system indicates the position of a first element of the calibration object and to detect a second signal by the second sensor system, wherein the second signal detected by the second sensor system indicates the position of a second element of the calibration object. According to the invention, the signals indicating the positions of the first and the second element of the calibration object of both sensor systems are detected simultaneously. In case a chain is part of the calibration object the two sensor systems each detect signals from a chain component at the same time wherein the signals detected from these chain components are used to analyze the distance between these two chain components. By using a calibration object, the method according to the invention provides a reproducible distance between the two sensor systems. In a development of the invention, the two sensor systems form a sensor device.

In an embodiment of the invention the sensor device is suitable to use the signals detected by the first and the second sensor systems indicating the positions of the first and the second elements of the calibration object to adjust the first and/or the second sensor system to a defined distance and/or to calculate the distance between the first and the second sensor system.

In a further embodiment of the invention is suitable to use the first and the second sensor with defined distance between each other for monitoring the state of wear of an unknown chain different from the calibration object. By using a calibration object, the method according to the invention provides a reproducible distance between the two sensor systems. In a development of the invention, the two sensor systems form a sensor device. The calibrated sensor device can be mounted nearby a chain to be monitored without changing the configuration of the sensor device or changing the distance between the first and the second sensor system.

In a further embodiment of the invention the sensor device is suitable monitoring the state of wear by simultaneously detecting a first signal from a first chain component by the first sensor system indicating the position of the first chain component and detecting a second signal from a second chain component by the second sensor system indicating the position of the second chain component, wherein the first and the second signal are used for analyzing the state of wear of the chain to be monitored. In a further embodiment the first and the second signal are used for analyzing the elongation of the chain to be monitored. In a further embodiment the first and the second signal are used for determining the distance between the first and the second chain component of the chain to be monitored.

In a further embodiment of the invention the first and the second sensor system of the sensor device have a defined and/or known distance between each other, which has been directly determined by a calibration object. In one example the distance of the first and the second sensor system is then directly determined from the known length of the calibration object. In another example the calibration object is able to measure and/or determine the position of the first and second sensor system relative to the distance between the two sensors to be setup. The first and the second sensor systems can then be adjusted according to the positions measured and/or determined by the calibration object.

In another embodiment of the invention the sensor device is suitable carrying out a first signal detection using the first sensor system in order to get a first signal from the calibration object and carrying out a second signal detection using the second sensor system in order to get a second signal from the calibration object. The signals detected by the first and the second sensor systems are then used to adjust the first and/or the second sensor system to a defined distance and/or to calculate the distance between the first and the second sensor system.

In a development of the invention the positions of the first and the second sensor systems are fixed after the calibration. It's important to keep the two sensor systems and therefore their distance fixed in order to achieve correct results while monitoring the wear of a chain.

In a further embodiment of the invention the sensor device has the first and second sensor system during complete operation for monitoring the state of wear of a chain with a unknown state of wear.

In a further embodiment of the invention the sensor device comprises an analytical unit for using the distance between the two sensors for monitoring the state of wear of a chain. In a further development of the invention the analytical unit is suitable for determining the length and/or elongation of the unknown chain with the fixed first and second sensor system. In a further development of the invention the analytical unit is suitable using the distance between the first and the second sensor system to determine length and or elongation of a chain. The elongation is a direct measure for the wear of a chain. Using the defined and known distance of the first and the second sensor system the elongation of the chain can be determined.

In a further embodiment of the invention the first and second sensor systems of the sensor device are arranged in one component, for example a housing with a fixed distance between each other. The component is positioned with the sensor systems installed in it. According to the invention, the sensor device is suitable simultaneously detecting the first signal of the first sensor system and the second signal of the second sensor system. The a sensor device are suitable to detect a chain component at the same time independently from the state of wear of the chain to be monitored. Most systems using laser barriers or similar technologies for triggering a marker or chain element passing the first and/or second sensor system. Those sensor elements are not suitable for detecting a signal by the first and the second sensor system at the same time independently of the wear state of the chain, because by the elongation caused by the wear time of the signal detected by the first sensor system is shifted relative to the signal detected by the second sensor system. Therefore a sensor system has to be used, which is suitable to detect the position of a marker of the chain and/or a chain component independently from its specific position at least over small detection area.

In a further embodiment of the invention the sensor device is suitable detecting the second positioning of the first and the second sensor system and/or the second signal detection by the first and the second sensor system at the same time during the calibration process and/or the monitoring of the wear state of a chain.

In a further embodiment of the invention, the sensor device has been calibrated for a specific type of a chain. The specific type of a chain is characterized in the pitch of the chain type for which the sensor is intended. The distance between the two sensor systems is usually approximately an integer multiple of the pitch of the chain type to be monitored in order to simultaneously detect the position of a first chain component using the first sensor system and the position of a second chain component using the second sensor system. In case a sensor system is used which is suitable to detect the position of a marker of the chain and/or a chain component independently from its specific position at least over small detection area, the detection areas of the first and the second sensor systems the distance between the two sensor systems don't have to be exactly an integer multiple of the pitch of the chain to be monitored in order to simultaneously detect the position of a first chain component using the first sensor system and the position of a second chain component using the second sensor system. But the difference of the distance of the two sensors to an integer of the pitch of the chain has to be smaller than the detection areas of the first and/or the second sensor systems.

In a further embodiment of the invention, the first sensor system and/or the second sensor system are suitable for detecting the position of a chain component. The sensor systems are at a defined distance from one another, which corresponds to the pitch or an integer multiple of the pitch of the chain. The distance between the two sensors is a parameter for calculating the length value of the chain. The signals to the first and second sensor systems are detected continuously and simultaneously during monitoring the wear state of the chain. In a further embodiment of the invention the wear state of the chain, the elongation and/or the length value, like the distance between the chain components, is continuously and simultaneously determined.

In a further embodiment of the invention, the first and/or the second sensor system are suitable for detecting the signals of a chain component, in order to determine the position of the chain component simultaneously over a path length range of the chain for which the sensor (the sensor system) is provided. The sensor systems are position sensitive sensors and constructed in such a way that the position of the chain component is determined over a length range in movement direction of the chain. The sensor device is suitable for simultaneously detecting the signals by the first and the second sensor system during the calibration process and/or during the monitoring process from different positions of the calibration object or the chain to be monitored even in case the chain length will be changed during its use. By this way a marker or specific chain component can be simultaneously detected over a pathlength of the chain without changing the configuration of the sensor device or the position of one of the sensor systems. The chain components therefore cover a distance in the detection range of the sensors, within which the position of the chain components is determined.

In another embodiment of the invention, the chain type is a British Standard or ANSI Standard chain. The individual dimensions of the chain components are partly different in the British Standard chain and in the ANSI Standard. The roller diameters, for example, often differ from each other.

In a development of the invention, the pitch of the chain corresponds to 12.700 mm, 15.875 mm, 19.050 mm, 25.400 mm, 31.750 mm, 38.100 mm, 44.450 mm or 50.800 mm. The pitches of the standard chains according to British Standard (DIN 8188) or ANSI Standard (DIN 8187) are the same.

In an advantageous embodiment of the invention, the first sensor system is suitable for determining the position of a first chain component exclusively from the measured values detected by the first sensor system and/or the second sensor system is suitable for determining the position of a second chain component exclusively from the measured values detected by the second sensor system. The distance between the two chain components is determined from the position.

In a development of the invention, the sensor device is suitable for simultaneously detecting the measured values for determining the position of the first chain component and the position of the second chain component. The distance between the chain components is also determined simultaneously. In addition, the first and second detection and the determination of the distance between the chain components advantageously take place continuously. Therefore, fault states of the monitored chain can be detected quickly and reliably, and the elongation of the chain can also be detected statistically over a longer period of time.

In an advantageous embodiment of the invention, the first sensor and/or the second sensor are suitable for detecting the measured values for determining the position of the first or second chain component over a path length range of the chain. The sensor systems are constructed in such a way that the position of the chain component is determined over a length range. The chain components therefore cover a distance in the detection range of the sensors, within which the position of the chain components is determined.

In a further embodiment of the invention, the path length range is greater than or equal to ½ segment length. The segments provide a complete coverage of at least those parts of the chain that are accessible to the chain sensor device for detecting the position. The length or number of segments depends on the length of the chain to be monitored.

In a further embodiment of the invention, the segment length corresponds to the distance between the first chain component and the directly adjacent chain component. In the ideal case, the number of segments corresponds to the number of chain links in the chain to be monitored, so that each individual chain link is monitored with regard to its physical characteristics.

In an optional embodiment of the invention, the first and/or the second sensor of the sensor device detect the measured values for determining the position of the chain components independently of the speed and/or the position of the chain to be monitored. In an optional embodiment, the first and/or the second sensor are suitable for detecting the measured values for determining the position of the chain components when the chain speed is 0. In further embodiments of the invention, the measured values for determining the position of a chain component can be acquired at any time.

In an optional development of the invention, the first and/or the second sensor simultaneously detect the measured values for determining the position of a chain component over the path length range of the chain.

In a development of the invention, the sensor device is suitable and provided for simultaneously detecting the measured values from the first and/or the second sensor over a length range of the chain. The length range of the chain extends in the direction of movement of the chain.

In a further embodiment of the invention, the length range is greater than or equal to half the length of a chain link, preferably greater than or equal to ¾ of the length of a chain link and particularly preferably greater than the length of a chain link. The length of a chain link results from the defined standard according to a standard chain according to British Standard (DIN 8188) or ANSI Standard (DIN 8187).

In a further embodiment according to the invention, the first and/or the second sensor have at least two sensor elements forming the first and/or the second sensor. These are the primary coil and the secondary coils of the differential transformer or, for example, two or more photodiodes of a CCD chip, which are arranged along the direction of chain movement. The distance between the at least two sensor elements is limited to a length of less than twice a chain link of the chain to be monitored. The length of a chain link results from the defined standard according to a standard chain according to British Standard (DIN 8188) or ANSI Standard (DIN 8187).

Exemplary embodiments of the method according to the invention for setting up a sensor device for monitoring the state of wear of a chain and of the sensor device according to the invention are shown in a schematically simplified way in the drawings and are explained in more detail in the following description.

### BRIEF DESCRIPTION OF THE FIGURES

Some non-limiting exemplary embodiments or features of the disclosed subject matter are illustrated in the following drawings.

Identical, duplicate, equivalent or similar structures, elements, or parts that appear in one or more drawings are generally labeled with the same reference numeral, optionally with an additional letter or letters to distinguish between similar entities or variants of entities, and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

References to previously presented elements are implied without necessarily further citing the drawing or description in which they appear.

FIG. 1 is a schematic illustration of a sensor device, according to certain exemplary embodiments;

FIG. 2a is a side view of the first part of the calibration object according to the invention

FIG. 2b is a side view of the second part of the calibration object, according to certain exemplary embodiments;

FIG. 2c is a plan view of the first part of the calibration object, according to certain exemplary embodiments;

FIG. 3 is a schematic illustration a calibration object of the subject matter ready for use, according to certain exemplary embodiments

FIG. 4 is a schematic illustration of another exemplary embodiment of the sensor device with a common decentralized control, according to certain exemplary embodiments;

FIG. 5 outlines operations of a method according to the invention, according to certain exemplary embodiments

FIG. 6 outlines alternative operations of a method according to the invention, according to certain exemplary embodiments; and

FIG. 7 is a schematic illustration of the dimensions of a standardized chain according to the NASI Standard or the British Standard.

### DETAILED DESCRIPTION

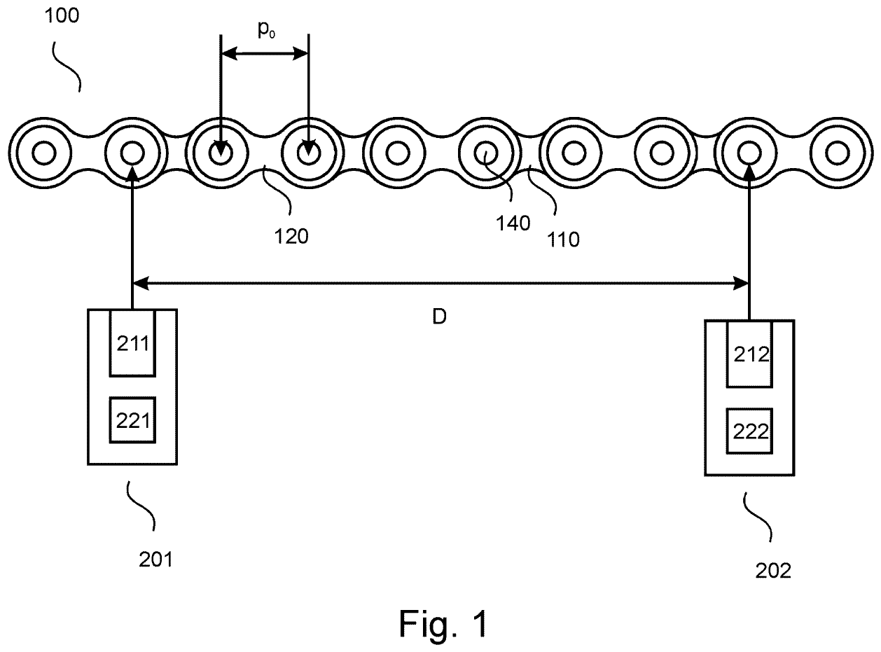

FIG. 1 shows the sensor device 200 according to the invention for determining the elongation of segments of a chain 100. In this and the following exemplary embodiments, the chain 100 to be monitored is designed as a one-piece roller chain and has alternating inner 110 and outer side parts 120 which are connected to one another by chain link pins 140 guided in chain bushings 130. When the chain 100 is new, the chain pins 140 are at a distance p0 from one another.

The length L0 of the chain 100 in new condition between the sensors 201, 202 is an integer multiple of the distance p0 between two adjacent chain pins 140 (L0=n*p0). Each sensor system 201, 202 has a respective sensor 211, 212, which is designed as a differential transformer in this and the following exemplary embodiments. In addition, each sensor system 201, 202 has a control 221, 222. The sensor systems 201, 202 together with the electrical connections are arranged in a housing (not shown) for protection against dirt.

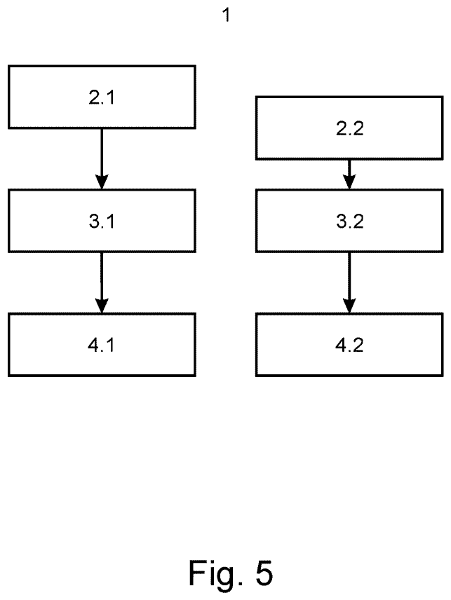

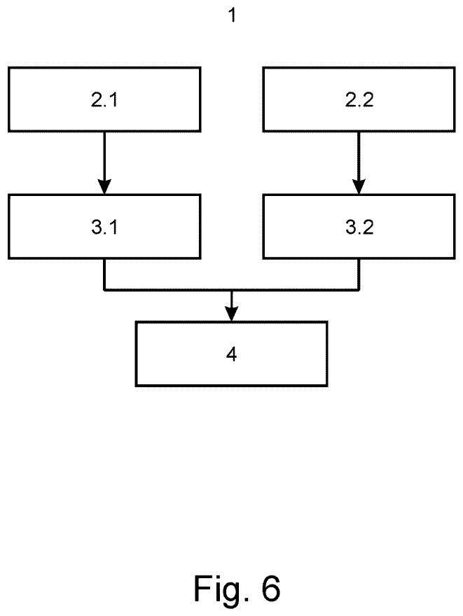

To determine the elongation of chain 100 during operation, the sensor device 200 is positioned perpendicular to the joint axis of the chain 100 to be monitored in such a way that when the chain 100 is new, the distance D between sensor systems 201, 202 corresponds to an integer multiple of distances p0 between two adjacent chain pins 140 of the chain 100 to be monitored. Method 1 according to the invention for setting up a sensor device 201, 202 is carried out for performing the precise calibration of the positioning of the sensor systems 201, 202 at the stated correct distance D from one another (see FIGS. 5, 6).

For this purpose, a first positioning 2 of the first sensor system 201 and a first positioning 3 of the second sensor system 202 in relation to the calibration object 400 are performed. A first signal detection is then carried out using the first sensor system 201 4, and at the same time a second signal detection 5 using the second sensor system 202 takes place. The method according to the invention provides a reproducible distance D between the sensor systems 201, 202.

The sensors 211, 212 are composed of a primary coil and two secondary coils and therefore have three sensor elements. Each of the differential transformers 211, 212 is thus suitable for simultaneously recording measured values over a length range of the chain 100 to be monitored. The length of the length range in the direction of the chain movement is based on the length p, p0 of a chain link of the chain 100 to be monitored and equals p0 in this exemplary embodiment. The detection of the measured values by the two differential transformers 211, 212 also takes place simultaneously.

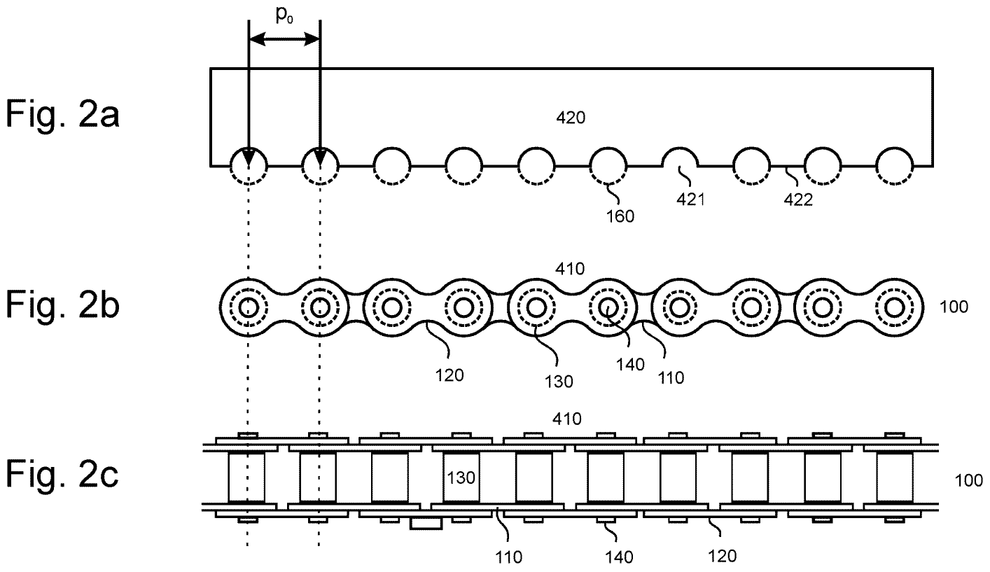

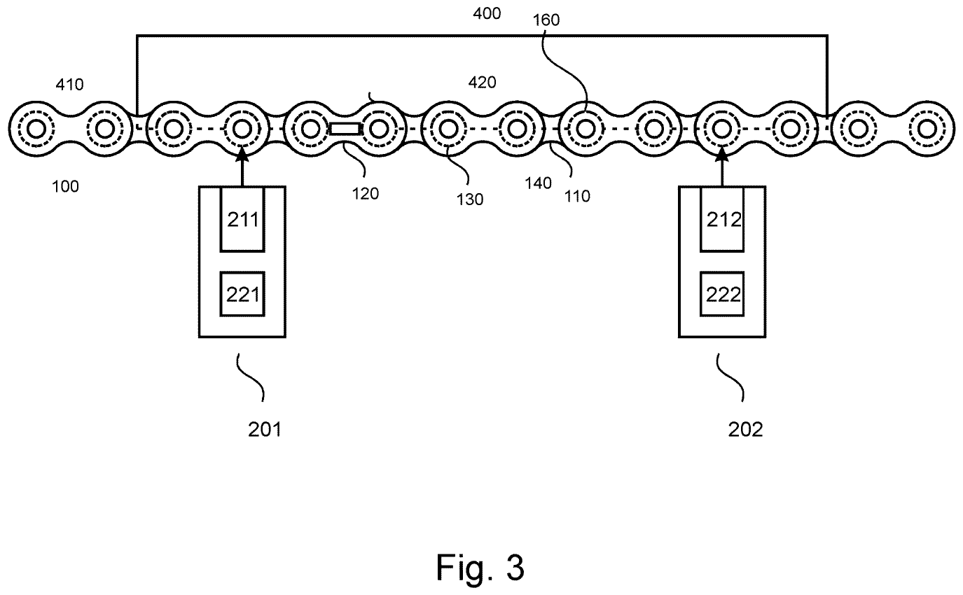

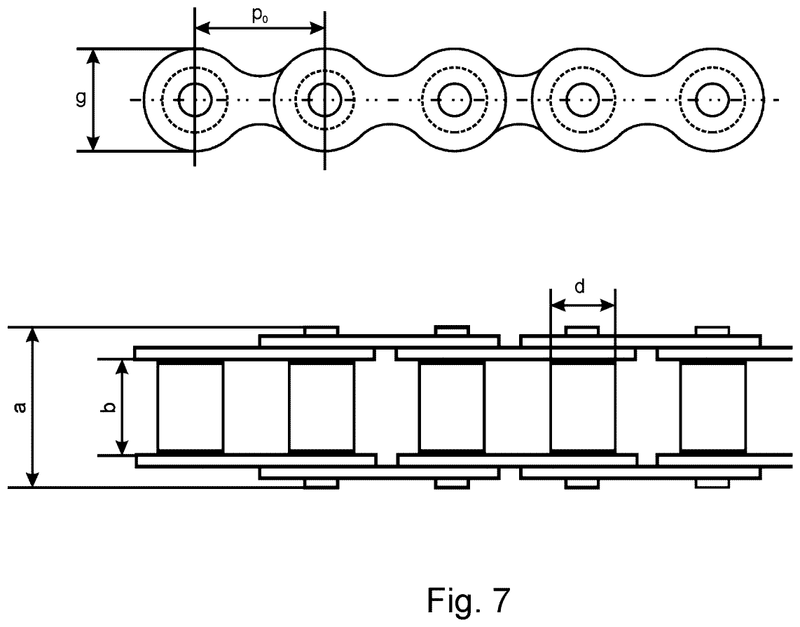

The calibration object 400, which is used in the method 1 according to the invention, is shown in FIGS. 2 and 3. The calibration object 400 has two parts 410, 420: the first part 410 is the actual chain 100 to be monitored (FIG. 2 b, c) or a chain section of a chain type of the chain 100 to be monitored. The chain 100 is a one-piece sleeve-type chain as described in FIG. 1. Alternatively, a roller chain can also be used. Such a chain 100 to be monitored is a standard chain according to ANSI Standard of the American type (DIN 8187) or according to British Standard (BS, DIN 8188). The chains according to these standards do not differ in the respective pitches p0. The chains according to ANSI Standard or British Standard differ in other dimensions (see FIG. 7), for example in the length of the chain pins.

The second part of the calibration object 400 is a template 420 (FIG. 2a) which has recesses 421 and serrations 422. The recesses 421 in the form of a semicircle or a segment of a circle have a center distance from one another which corresponds to the pitch p0 of the chain type whose elongation ΔL is to be monitored by the sensor device 200. The diameter of the recesses 421 also corresponds to the diameter of the chain bushings d of the chain type whose elongation ΔL is to be monitored with the sensor device 200.

The chain 100 for carrying out the method 1 according to the invention for setting up a sensor device 201, 202 is arranged ready for use (FIG. 3) on the template 420 in such a way that the chain bushings 130 are arranged in the recesses 421. The sensor systems 201, 202 are then positioned in such a way that the distance D between the sensor systems 201, 202 corresponds exactly to an integer multiple of the distances p0 between two adjacent chain pins 140 of the chain 100 to be monitored. In the case of a roller chain, the rollers are positioned in the template 420 and the corresponding roller dimensions for the template 420 are used.

An exemplary, incomplete listing with the dimensions according to FIG. 7 of different one-piece roller chains according to ANSI Standard of the American type (DIN 8187) or according to British Standard (BS, DIN 8188) is shown in the following table. Method 1 according to the invention can be used for all of these chain types. However, the second part 420 of the calibration object 400 must be selected accordingly for each chain type according to the pitch p0 and the diameter d of the chain bushings 130.

| Pitch × | | DIN | | | | Roller | Plate | Joint |
|---|---|---|---|---|---|---|---|---|
| inner | | ISO | Pitch p₀ | Inside b | Outside a | diameter d | height g | area f |
| width | | number | (mm) | (mm) | (mm) | (mm) | (mm) | (cm²) |
| ½ × 5/16″ | | 08B-1 | 12.7 | 7.75 | 16.9 | 8.51 | 12.2 | 0.5 |
| ½ × 8/16″ | ANSI40 | 08A-1 | 12.7 | 7.94 | 16.6 | 7.95 | 12 | 0.44 |
| ⅝ × ⅜″ | | 10B-1 | 15.875 | 9.65 | 19.5 | 10.16 | 14.4 | 0.67 |
| ⅝ × ⅜″ | ANSI50 | 10A-1 | 15.875 | 9.53 | 20.4 | 10.16 | 14.4 | 0.7 |
| ¾ × 7/16″ | | 12B-1 | 19.05 | 11.75 | 22.7 | 12.07 | 16.4 | 0.89 |
| ¾ × ½″ | ANSI60 | 12A-1 | 19.05 | 12.7 | 25.3 | 11.91 | 18 | 1.06 |
| 1″ × 17 mm | | 16B-1 | 25.4 | 17.02 | 36.1 | 15.88 | 21.1 | 2.1 |
| 1 × ⅝″ | ANSI80 | 16A-1 | 25.4 | 15.88 | 32.1 | 15.88 | 22.8 | 1.79 |

British Standard - DIN 8187;
ANSI Standard - DIN 8188

Min. and max. dimensions for the chains are specified in the respective standards. The table above shows concrete nominal dimensions as an example

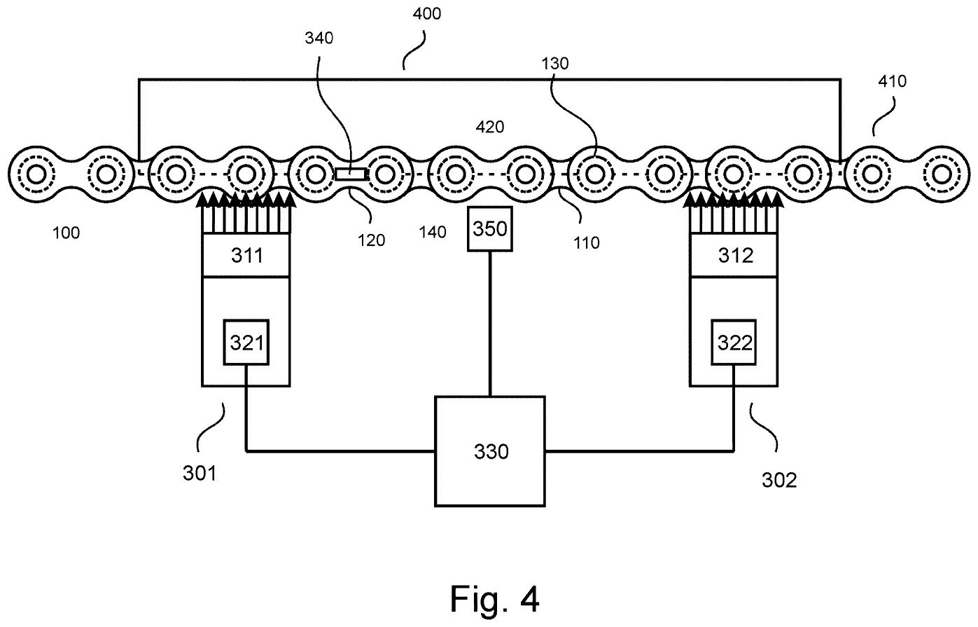

FIG. 4 shows a further exemplary embodiment of setting up a sensor device 300 according to the invention for determining the elongation of segments of a chain 100. The sensor device 300 has two sensor systems 301, 302 connected by an evaluation circuit 330. The sensor systems 301, 302 are positioned using method 1 according to the invention such that when the chain 100 is new, the distance D between the sensor systems 301, 302 corresponds exactly to an integer multiple of the distances p0 between two adjacent chain pins 140 of the chain 100 to be monitored.

The sensor systems 301, 302 can be designed as inductively operating differential transformers, with which the position of chain components is determined. Such sensor systems 301, 302 detect chain components—in this exemplary embodiment the chain bushings 140—over a length range of the sensors 311, 312.

The symmetry of the sensors 311, 312 is disturbed by the passage of the chain component 140. The asymmetry created by the chain component 140 is greatest when the chain component 140 is arranged in the region of the sensors 311, 312 at the edges of the sensors 311, 312, i.e. is moved out of or into the sensor region. The sensors 311, 312 then generate a maximum output voltage U when the chain component 130 is positioned at the edge of the sensors 311, 312. The asymmetry and the resulting output voltage generated by the sensors 311, 312 is U=0 when the chain component 140 is positioned in the middle of the sensors 311, 312. The length value is determined via the pitch (distance between two adjacent chain links of the chain). The length value, like the distance between the chain components, is continuously and simultaneously determined.

The sensor system 301 generates the positions via the trigonometric functions A sin and A cos, the sensor system 302 generates the positions via the trigonometric functions B sin and B cos. The elongation ΔL of the chain 100 then results from the position differences, which are calculated from the two sensor systems 301, 302:

$$Δ L / L 0 = ( arctan ( B sin / B cos ) - arctan ( A sin / A cos ) ) / D$$

However, the sensor systems 301, 302 can also be optical or magnetic sensors or a combination of the types of sensors mentioned. The sensor systems 301, 302 are each connected to an evaluation circuit 330. The controls 321, 322 supply the detected measured values to an evaluation circuit 330, in which the analog measured values are converted into digital values and stored on the microcontroller. In this exemplary embodiment, a permanent magnet 340 is arranged on chain 100, the position of which is detected by means of a Hall sensor 350 and the evaluation circuits 330. The microcontroller of the evaluation circuit 330, which is connected to the Hall sensor 350, registers the position of the permanent magnet 340 and enables the individual chain links to be identified by continuously counting the passages of the permanent magnet 340 on the sensor systems 301, 302.

An exemplary embodiment of method 1 according to the invention for setting up a sensor device for monitoring the state of wear of a chain 100 is shown in FIG. 5. For this purpose, a first positioning 2.1 of the first sensor system 201 as well as a first positioning 2.2 of the second sensor system 202 relative to the calibration object 300 are performed. A first signal detection 3.1 is then carried out using the first sensor system 201, and at the same time a second signal detection 3.2 is carried out using the second sensor system 202. This is followed by a separate evaluation 4.1, 4.2 for each sensor system 201, 202 of the measured values determined by the first sensor system 201 and second sensor system 202 with regard to whether the two sensor systems 201, 202 simultaneously detect a chain component 130. The method 1 according to the invention provides a reproducible distance D between the sensor systems 201, 202. In this context is important at which position in the sensor region the chain components 130 are located—this is how the sensor learns the correct distances p0 and compensates for the individual production-related deviations. The method 1 according to the invention is advantageously carried out several times in succession in order to detect and compensate for any fault states due to different chain geometries over the chain length and due to mechanical and metrological tolerances.

FIG. 6 shows a variant of the method 1 according to the invention for setting up a sensor device for monitoring the state of wear of a chain 100. For this purpose, a first positioning 2.1 of the first sensor system 201 and a first positioning 2.2 of the second sensor system 202 in relation to the calibration object 400 are performed. A first signal detection 3.1 is then carried out using the first sensor system 201, and at the same time a second signal detection 3.2 is carried out using the second sensor system 202. This is followed by an evaluation 4 of the measured values determined by the first sensor system 201 and second sensor system with regard to whether the two sensor systems 201, 202 simultaneously detect a chain component 130. Method 1 is also carried out several times.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as the ordinary context of the art, such as a general purpose processor or a micro-processor, RISC processor, or DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ also denote a plurality of processors or computers connected, and/or linked, and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry.

The processor and program may constitute the same apparatus, at least partially, such as an array of electronic gates, such as FPGA or ASIC, designed to perform a programmed sequence of operations, optionally comprising or linked with a processor or other circuitry.

The term computerized apparatus or a computerized system or a similar term denotes an apparatus comprising one or more processors operable or operating according to one or more programs.

As used herein, without limiting, a module represents a part of a system, such as a part of a program operating or interacting with one or more other parts on the same unit or on a different unit, or an electronic component or assembly for interacting with one or more other components.

As used herein, without limiting, a process represents a collection of operations for achieving a certain objective or an outcome.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprises” and/or “comprising” and/or “having” when used in this specification, specify the presence of stated features, integers, steps, operations, elements, and/or components, but do not preclude the presence or addition of one or more other features, integers, steps, operations, elements, components, and/or groups thereof.

As used herein the term “configuring” and/or ‘adapting’ for an objective, or a variation thereof, implies using materials and/or components in a manner designed for and/or implemented and/or operable or operative to achieve the objective.

Unless otherwise specified, the terms ‘about’ and/or ‘close’ with respect to a magnitude or a numerical value implies within an inclusive range of −10% to +10% of the respective magnitude or value.

Unless otherwise specified, the terms ‘about’ and/or ‘close’ with respect to a dimension or extent, such as length, implies within an inclusive range of −10% to +10% of the respective dimension or extent.

Unless otherwise specified, the terms ‘about’ or ‘close’ imply at or in a region of, or close to a location or a part of an object relative to other parts or regions of the object.

When a range of values is recited, it is merely for convenience or brevity and includes all the possible sub-ranges as well as individual numerical values within and about the boundary of that range. Any numeric value, unless otherwise specified, includes also practical close values enabling an embodiment or a method, and integral values do not exclude fractional values. A sub-range values and practical close values should be considered as specifically disclosed values.

As used herein, ellipsis ( . . . ) between two entities or values denotes an inclusive range of entities or values, respectively. For example, A . . . Z implies all the letters from A to Z, inclusively.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

Terms in the claims that follow should be interpreted, without limiting, as characterized or described in the specification.

### LIST OF REFERENCE NUMERALS

1 method for setting up a sensor device to monitor the state of wear of a chain
2.1 first positioning of the first sensor system
2.2 first positioning of the second sensor system
3.1 first signal detection using the first sensor system
3.2 second signal detection using the second sensor system
4, 4.1, 4.2 evaluation
100 chain
110 chain inner link
120 chain outer link
130 chain bushing
140 chain pin
200 sensor device
201 first sensor system
202 second sensor system
211, 212 sensor
221, 222 control
300 sensor device
301 first sensor system
302 second sensor system
311, 312 sensor
321, 322 control
330 evaluation circuit
340 permanent magnet
350 Hall sensor
400 calibration object
410 first part of the calibration object/chain
420 second part of the calibration object/measuring template
421 recess
422 serration
d roller diameter
p0 pitch (distance between two adjacent chain pins) in new condition
p pitch (distance between two adjacent chain pins) in actual condition
L0 length of chain between first and second sensor system, new condition
L length of chain between first and second sensor system, actual condition
ΔL elongation of the chain
D distance from 1st sensor system to 2nd sensor system

1. A method for setting up sensor device for monitoring the state of wear of a chain, the method comprising:
positioning of a first sensor system relative to a calibration object;
positioning of a second sensor system relative to the calibration object;
detecting a first signal by the first sensor system, wherein the first signal detected by the first sensor system indicates the position of a first element of the calibration object
detecting a second signal by the second sensor system, wherein the second signal detected by the second sensor system indicates the position of a second element of the calibration object characterized in that
the signals indicating the positions of the first and the second element of the calibration object of both sensor systems are detected simultaneously,
wherein the sensor device is suitable to monitor the state of wear of a chain different from the calibration object.

2. The method for setting a sensor device for monitoring the state of wear of a chain according to claim 1
characterized in that
the signals detected by the first and the second sensor systems indicating the positions of the first and the second elements of the calibration object are then used to adjust the first and/or the second sensor system to a defined distance and/or to calculate the distance between the first and the second sensor system.

3. The method for setting up a sensor device for monitoring the state of wear of a chain according to claim 1
characterized in that
the first and the second sensor with defined distance between each other are used for monitoring the state of wear of an unknown chain different from the calibration object.

4. The method for setting up a sensor device for monitoring the state of wear of a chain according to claim 1
characterized in that
the method of monitoring the state of wear comprise simultaneously detecting a first signal from a first chain component by the first sensor system indicating the position of the first chain component and detecting a second signal from a second chain component by the second sensor system indicating the position of the second chain component, wherein the first and the second signal are used for analyzing the state of wear of the chain to be monitored,
wherein the first and the second signal are used for analyzing the elongation of the chain to be monitored,
wherein the first and the second signal are used for determining the distance between the first and the second chain component of the chain to be monitored.

5. The method for setting up a sensor device for monitoring the state of wear of a chain according to claim 1
characterized in that
a second positioning of the first and/or the second sensor system relative to the calibration object takes place, the second positioning being different from the first positioning, and/or a second signal detection takes place with the first and/or second sensor system,
wherein the second positioning of the first and the second sensor system and/or the second signal detection by the first and the second sensor system takes place at the same time.

6. The method for setting up a sensor device for monitoring the state of wear of a chain according to claim 1
characterized in that
the calibration object is designed in two parts.

7. The method for setting up a sensor device for monitoring the state of wear of a chain according to claim 5
characterized in that
the first part of the calibration object is a chain,
wherein the second part of the calibration object is an element with the aid of which chain components can be positioned in relation to one another.

8. The method for setting up a sensor device for monitoring the state of wear of a chain according to claim 1
characterized in that
the method for setting up a sensor device for monitoring the state of wear of a chain takes place depending on the chain type for which the sensor (the sensor systems) should be used,
wherein the chain type is a standard chain,
wherein the chain type is a standard chain according to British Standard or ANSI Standard.

9. The method for setting up a sensor device for monitoring the state of wear of a chain according to claim 1
characterized in that
the method for setting up a sensor device for monitoring the state of wear of a chain takes place depending on the chain type for which the sensor (the sensor systems) should be used,
wherein the pitch of the chain corresponds to 12.700 mm, 15.875 mm, 19.050 mm, 25.400 mm, 31.750 mm, 38.100 mm, 44.450 mm or 50.800 mm.

10. The method for setting up a sensor device for monitoring the state of wear of a chain according to claim 1
characterized in that
the first sensor system and/or the second sensor system are suitable for detecting the position of a chain component,
wherein the first and/or the second sensor system are suitable for detecting the signals of a chain component to determine the position of the chain component over a path length range of the chain, for which the sensor system is provided,
wherein the path length range is greater than or equal to ½ the pitch p0 of the chain, preferably greater than or equal to ¾ the pitch p0 of the chain and more preferably greater than or equal to the pitch (p0) of the chain for which the sensor system is provided.

11. A sensor device for determining states of wear of a chain with a first sensor system and a second sensor system,
wherein the sensor device is set up with a calibration object for a standard chain and/or a standard pitch,
wherein the sensor device is suitable to monitor the state of wear of a chain different from the calibration object.

12. The sensor device of claim 11 for determining states of wear of a chain
characterized in that
the sensor device has been calibrated by a method comprising:
positioning of a first sensor system relative to a calibration object,
positioning of a second sensor system relative to the calibration object,
detecting a first signal by the first sensor system, wherein the first signal detected by the first sensor system indicates the position of a first element of the calibration object,
detecting a second signal by the second sensor system, wherein the second signal detected by the second sensor system indicates the position of a second element of the calibration object,
characterized in that
the signals indicating the positions of the first and the second element of the calibration object of both sensor systems are detected simultaneously, and
wherein the sensor device is suitable to monitor the state of wear of a chain different from the calibration object.

13. The sensor device of claim 11 for determining states of wear of a chain
characterized in that
the sensor device is suitable to detect a first signal by the first sensor system, wherein the first signal detected by the first sensor system indicates the position of a first element of the calibration object and to detect a second signal by the second sensor system, wherein the first signal detected by the second sensor system indicates the position of a second element of the calibration object,
wherein the sensor device is suitable to use the signals detected by the first and the second sensor systems indicating the positions of the first and the second elements of the calibration object to adjust the first and/or the second sensor system to a defined distance and/or to calculate the distance between the first and the second sensor system.

14. The sensor device of claim 11 for determining states of wear of a chain
characterized in that
the sensor device is suitable to use the first and the second sensor with defined distance between each other for monitoring the state of wear of an unknown chain different from the calibration object,
wherein the two sensor systems form a sensor device.

15. The sensor device of claim 11 for determining states of wear of a chain
characterized in that
the calibrated sensor device can be mounted nearby a chain to be monitored without changing the configuration of the sensor device or changing the distance between the first and the second sensor system.

16. The sensor device of claim 11 for determining states of wear of a chain
characterized in that
the sensor device is suitable monitoring the state of wear by simultaneously detecting a first signal from a first chain component by the first sensor system indicating the position of the first chain component and detecting a second signal from a second chain component by the second sensor system indicating the position of the second chain component, wherein the first and the second signal are used for analyzing the state of wear of the chain to be monitored. In a further embodiment the first and the second signal are used for analyzing the elongation of the chain to be monitored.

17. The sensor device of claim 11 for determining states of wear of a chain
characterized in that
the first and second sensor systems of the sensor device are arranged in one component, for example a housing with a fixed distance between each other
wherein the positions of the first and the second sensor systems are fixed after the calibration,
wherein the sensor device is suitable simultaneously detecting the first signal of the first sensor system and the second signal of the second sensor system.

18. The sensor device of claim 11 for determining states of wear of a chain
characterized in that
the first sensor system and/or the second sensor system are suitable for detecting the position of a chain component.

19. The sensor device of claim 11 for determining states of wear of a chain
characterized in that
the first and/or the second sensor system are suitable for detecting the signals of a chain component, in order to determine the position of the chain component simultaneously over a path length range of the chain for which the sensor (the sensor system) is provided.

20. The sensor device for determining elongations of segments of a chain according to claim 11
characterized in that
the first sensor and/or the second sensor are suitable for detecting the measured values for determining the position of the first or second chain component over a path length range of the chain,
wherein the path length range is greater than or equal to ½ segment length,
wherein the segment length corresponds to the distance between the first chain component and the directly adjacent second chain component.
